(19) United States
(12) Patent Application Publication
(10) Pub. No.: US 2010/0086009 A1
(43) Pub. Date: Apr. 8, 2010

(54) SPREAD-SPECTRUM CLOCK GENERATOR AND SPREAD-SPECTRUM CLOCK GENERATING METHOD

(75) Inventor: Song-Rong Han, Taipei County (TW)

Correspondence Address: J C PATENTS, 4 VENTURE, SUITE 250, IRVINE, CA, 92618, US

(73) Assignee: FARADAY TECHNOLOGY CORP., Hsinchu (TW)

(21) Appl. No.: 12/246,953

(22) Filed: Oct. 7, 2008

(51) Int. Cl. H04B 1/69

(52) U.S. Cl. 375/130; 375/E01.001

(57) ABSTRACT

A spread-spectrum clock generator (SSCG) and a spread-spectrum clock generating method are provided. The SSCG includes a first spread-spectrum module, a second spread-spectrum module, and a waveform module. The first spread-spectrum module generates a first spread-spectrum clock signal by modulating the frequency of a first input clock signal with a parallel delay configuration. The second spread-spectrum module generates a second spread-spectrum clock signal by modulating the frequency of a second input clock signal with the same parallel delay configuration. The waveform module is coupled to the first spread-spectrum module and the second spread-spectrum module for generating an output spread-spectrum clock signal according to the first and the second spread-spectrum clock signals.

### BACKGROUND OF THE INVENTION

1. Field of the Invention

The present invention generally relates to a spread-spectrum clock generator (SSCG), and a spread-spectrum clock generating method, and more particularly, to a parallel type SSCG, and a spread-spectrum clock generating method thereof.

2. Description of Related Art

Spread-spectrum is a technology of modulating a clock signal. Frequencies of ordinary clock signals which are not performed with a spread-spectrum operation are constant. Spread-spectrum means modulating the frequency of a clock signal so that the energy of the clock signal is distributed into more spectrum tones in order to reduce electro-magnetic interference (EMI) of the clock signal. After spread-spectrum, magnitudes of individual spectrum tones are decreased and the EMI is reduced. FIG. 1A and FIG. 1B illustrate two conventional methods for spreading spectrum. FIG. 1A illustrates a down spread method, in which the spectrum is spread toward lower frequency. The original signal spectrum is marked as 102, and the spread-spectrum clock signal spectrum is marked as 101. FIG. 1B illustrates a center spread method, in that the spectrum is spread toward higher frequency and lower frequency at the same time. The original signal spectrum is marked as 104, and the spread-spectrum clock signal spectrum is marked as 105.

FIG. 2 illustrates a typical clock frequency modulation profile. There are two major factors for spread-spectrum. The first major factor is modulation percentage (MP), which is a ratio of a maximum frequency variation with an original clock frequency. The profile of FIG. 2 describes a center spread-spectrum, in which the original frequency before spreading the spectrum is F_{center}, and the MP=(Fₘₐₓ−F_{center})/F_{center} or (F_{center}−Fₘᵢₙ)/F_{center}. The second major factor is modulation frequency (MF), which is a reciprocal of a period of the modulation profile. For example the MF of the profile of FIG. 2 is F_{MOD}.

FIG. 3 describes several conventional clock frequency modulation profiles and their corresponding output spectrums. FIG. 3 can be considered as a 3×2 chart, in which the first column shows three kinds of conventional modulation profiles including sine wave, triangular wave, and Hershey's Kiss. The second column shows spectrums of clock signals modulated by the corresponding modulation profiles of the first column. As shown in FIG. 3, Hershey's Kiss is the best modulation profile, which outputs a spectrum having the most even and lowest magnitude, thus suffering the least EMI.

FIG. 4 is a schematic circuit diagram of a conventional SSCG 400 based on a phase-locked loop (PLL). The PLL includes dividers 401, 402, a phase/frequency detector 403, a charge pump 404, and a voltage control oscillator (VCO) 405. A low-pass filter including a resistor R1 and capacitors C1 and C2 is provided for smoothing the output of the charge pump 404 and stabilizing the frequency variation of the output clock signal Fout. A triangular wave supplied at the node 406 controls the frequency modulation of the output clock signal Fout.

In this kind of spread-spectrum clock generators, loop bandwidths of the PLLs are very low. As such, loop filters employed therein have to be designed to be very large, in that the capacitor C1 and C2 occupy very large areas which are one to three times of the rest circuit. Because of this two capacitors C1 and C2 having large areas, a locking time of the PLL is very much elongated, even up to twenty times of an ordinary PLL. Such a design not only increases overall area and production cost, but also causes unsatisfactory performance.

FIG. 5 is a schematic circuit diagram illustrating another conventional SSCG 500. The spread-spectrum clock generator employs a digital serial delay configuration, instead of the analog PLL configuration. The SSCG 500 includes two hundreds stages of serially connected delayers 511. Each of the delayers 511 includes a latch 512, and an inverter 5123 capable of varying a delay time thereof. The latch 512 has an output terminal Q controlling the delay time of the inverter 513. When the latch 512 outputs 1, the delay time of the inverter 513 is longer; and when the latch 512 outputs 0, the delay time of the inverter 513 is shorter. A multiplexer 521 and an inverter 522 constitute a control circuit 520 which output is Q₀. The two hundreds latches 512 of the SSCG 500 are serially connected and form a series. The two hundreds inverters 513 of the SSCG 500 are serially connected and form another series. During every period of an input clocks signal Fin, Q₀ is shifted to Q₂₀₀, and Q₂₀₀ is shifted to Q₁₉₉, Q₁₉₉ is shifted to Q₁₉₈, . . . , and finally Q₂ is shifted to Q₁.

At some moment, Q₁, Q₂, Q₃ . . . Q₂₀₀ are all zero, while the control circuit 520 sets Q₀ as 1. Being processed by the two hundreds inverters 513, the input clock signal Fin becomes the output clock signal Fout. Fin passes through two hundred times of short delays in total. At this moment, the output clock signal Fout has the shortest period and the highest frequency. In the next period, the rightmost latch 512 latches Q₀ so that Q₂₀₀ becomes 1, hence the input clock signal Fin are processed with 199 times of short delays and one time of long delay. In this case, the output clock signal Fout achieves a longer period, and a lower frequency. In such a way, as the logic 1 of the signal Q₀ gradually going inside the latch series, the frequency of the output clock signal Fout becomes lower and lower. When Q₁ through Q₂₀₀ are all logic 1, the output clock signal Fout achieves the lowest frequency, and meanwhile the control circuit 520 sets Q₀ to be 0. And in the next period, the logic 0 gradually goes inside the latch series, during which the long delays previously endured by the input clock signal Fin are one by one replaced by short delays, and the frequency of the output clock signal Fout gradually rises back. In such away, the spread-spectrum can be achieved by switching the signal Q₀ between 0 and 1 according to a certain rule with the control circuit 520.

The SSCG 500 is a purely digital design without any capacitor, and therefore has a smaller area. However, it still has disadvantages. For example, because of practical factors such as processing variations, operation voltage variations, and temperature variations, charging/discharging abilities of each stage of inverter 513 are likely to be asymmetrical. That means the pull-up ability and pull-down ability thereof are asymmetrical. Being accumulated after two hundreds stages, when the input clock signal Fin enters a high frequency region, the duty cycle of the output clock signal Fout will be drastically changed. In other words, the output clock signal Fout will seriously deform, or even saturate to be all high voltages or all low voltages. In this case, the SSCG 500 cannot be used anymore.

### SUMMARY OF THE INVENTION

Accordingly, the present invention is directed to provide a spread-spectrum clock generator (SSCG) for solving the problems of capacitor area, and the duty cycles existed in conventional technologies.

The present invention is further directed to provide a spread-spectrum clock generating method, for solving the problems of capacitor area, and the duty cycles existed in conventional technologies.

The present invention provides a spread-spectrum clock generator (SSCG), including a plurality of delayers, a multiplexer, and a channel selector. Each of the foregoing delayers delays an input clock signal, and generates a delay clock signal. The multiplexer is coupled to the delayers, for selecting one of the delay clock signals for outputting as a spread-spectrum clock signal according to a selection signal. The channel selector is coupled to the multiplexer, for providing the selection signal, and varying the selection signal during each period of the spread-spectrum clock signal.

According to an embodiment of the present invention, differences between each two of the delay times of the foregoing delayers constitute a numeral sequence which periodically varies between two predetermined values.

According to an embodiment of the present invention, the channel selector includes an up-down counter. The up-down counter is adapted for counting a value according to the spread-spectrum clock signal, and providing the counting value serving as the selection signal.

According to an embodiment of the present invention, the SSCG further includes a buffer chain, coupled to the delayers, for transmitting an input clock signal to the delayers, and driving the delayers.

According to an embodiment of the present invention, the SSCG further includes an inverter, coupled between the multiplexer and the channel selector, for receiving the spread-spectrum clock signal. The channel selector varies the selection signal during each period of an output signal of the inverter.

The present invention further provides a spread-spectrum clock generating method, including the steps of: first, providing a plurality of delay times, for delaying an input clock signal, and generating a plurality of delay clock signals; selecting one of the delay clock signals according to a selection signal for outputting as a spread-spectrum clock signal; and up-down counting according to the spread-spectrum signal, and providing a counting value serving as the selection signal.

According to an embodiment of the present invention, differences between each two of the delay times constitute a numeral sequence which periodically varies between two predetermined values.

The present invention further provides an SSCG, including a first spread-spectrum module, a second spread-spectrum module, and a waveform module. The first spread-spectrum module is adapted for modulating a first input clock signal for generating a first spread-spectrum clock signal. The second spread-spectrum module, is adapted for modulating a second input clock signal for generating a second spread-spectrum clock signal. The waveform module is coupled to the first spread-spectrum module and the second spread-spectrum module, for generating a spread-spectrum clock signal according to the first spread-spectrum clock signal and the second spread-spectrum clock signal.

According to an embodiment of the present invention, the first spread-spectrum module and the second spread-spectrum module have a same circuit configuration, and the second input clock signal is generated according to the first input clock signal.

According to an embodiment of the present invention, the SSCG further includes a delay unit. The delay unit is coupled to the second spread-spectrum module, for receiving the first input clock signal, and delaying the first input clock signal for a predetermined time and then outputting the delayed first input clock signal as the second input clock signal.

According to an embodiment of the present invention, the first spread-spectrum module includes a plurality of delayers, a multiplexer, and a channel selector. Each of the foregoing delayers delays the first input clock signal for generating a delay clock signal. The multiplexer is coupled to the delayers, for selecting one of the delay clock signals to serve as a first spread-spectrum clock signal according to a selection signal. The channel selector is coupled to the multiplexer, for providing the selection signal, and is adapted for varying the selection signal during each period of the first spread-spectrum clock signal.

According to an embodiment of the present invention, differences between each two of the delay times of the foregoing delayers constitute a numeral sequence which periodically varies between two predetermined values.

According to an embodiment of the present invention, the first spread-spectrum module further includes an up-down controller, coupled to the channel selector, for controlling an up-down counter of the channel selector according to the selection signal, so as to control an upper limit and a lower limit of the selection signal.

According to an embodiment of the present invention, the SSCG further includes a switch module. The switch module is coupled between the first spread-spectrum module, the second spread-spectrum module, and the waveform module, for disconnecting the first spread-spectrum clock signal from the waveform module and connecting the second spread-spectrum clock signal with the waveform module at the rising edge of the first spread-spectrum clock signal, and connecting the first spread-spectrum clock signal with the waveform module and disconnecting the second spread-spectrum clock signal from the waveform module at the rising edge of the second spread-spectrum clock signal.

According to an embodiment of the present invention, the switch module includes a first switch, a second switch, and a transition detector. The first switch is coupled with the first spread-spectrum module and the waveform module. The second switch is coupled between the second spread-spectrum module and the waveform module. The transition detector is coupled between the first switch and the second switch, and is adapted for turning off the first switch and turning on the second switch at the rising edge of the first spread-spectrum clock signal, and turning on the first switch and turning off the second switch at the rising edge of the second spread-spectrum clock signal.

According to an embodiment of the present invention, the waveform module includes a first pulse generator, a second pulse generator, and a waveform generator. The first pulse generator is coupled with the first spread-spectrum module, for generating a first pulse signal at the rising edge of the first spread-spectrum clock signal. The second pulse generator is coupled with the second spread-spectrum module, for generating a second pulse signal at the rising edge of the second spread-spectrum clock signal. The waveform generator is coupled with the first pulse generator and the second pulse generator, for generating an output spread-spectrum clock signal. A rising edge of the output spread-spectrum clock signal is generated according to the first pulse signal, and a falling edge of the output spread-spectrum clock signal is generated according to the second pulse signal.

The present invention further provides a spread-spectrum clock generating method including the steps of: first providing a predetermined spread-spectrum method for modulating a first input clock signal to obtain a first spread-spectrum clock signal; using the predetermined spread-spectrum method for modulating a second input clock signal to obtain a second spread-spectrum clock signal; and generating an output spread-spectrum clock signal according to the first spread-spectrum clock signal and the second spread-spectrum clock signal. A rising edge of the output spread-spectrum clock signal is generated according to a rising edge of the first spread-spectrum clock signal, and a falling edge of the output spread-spectrum clock signal is generated according to a rising edge of the second spread-spectrum clock signal.

According to an embodiment of the present invention, the second input clock signal is an inverted signal of the first input clock signal.

According to an embodiment of the present invention, the predetermined spread-spectrum method with respect to the first input clock signal includes the steps of: first, respectively delaying the first input clock signal according to a plurality of delay times respectively, for generating a plurality of delay clock signals; selecting one of the delay clock signals to serve as the first spread-spectrum clock signal according to a selection signal; and up-down counting according to the first spread-spectrum clock signal, and providing a counting value thereof serving as the selection signal.

According to an embodiment of the present invention, differences between each two of the delay times constitute a numeral sequence which periodically varies between two predetermined values.

The present invention is different from the conventional phase-locked loop (PLL) configuration, and does not demand for capacitors having large areas, and therefore provides a solution to the problem of capacitor areas of the conventional technology, while greatly shortening the latching time. Further, the present invention adopts an all digital parallel delaying configuration, instead of serial delaying configuration for much decreasing the delay stages, and further adopts two completely symmetrical circuits, responsible for a rising edge and a falling edge of a clock signal, respectively, and thus avoiding the deformation of the outputted clock signal, and providing the duty cycle problem of the conventional technology.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are schematic diagrams illustrating different types of conventional spread-spectrum operations for clock signals.

FIG. 2 illustrates a typical clock frequency modulation profile.

FIG. 3 is a schematic diagram illustrating several conventional clock frequency modulation profiles and their corresponding output spectrums.

FIGS. 4 and 5 are schematic circuit diagrams illustrating conventional spread-spectrum clock generators (SSCG).

FIG. 6 is a schematic circuit diagram illustrating an SSCG according to an embodiment of the present invention.

FIG. 7 is a clock sequence diagram of the delay clock signals of the SSCG of FIG. 6.

FIG. 8 is a schematic circuit diagram illustrating an SSCG according to another embodiment of the present invention.

FIGS. 9A and 9B are simulations of the SSCG of FIG. 8.

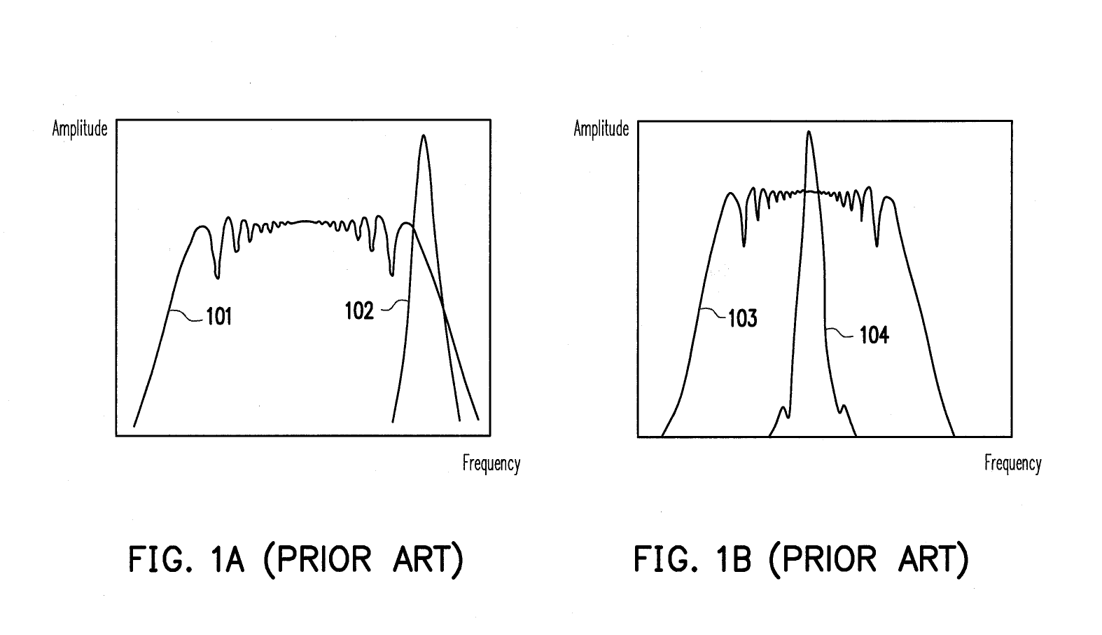

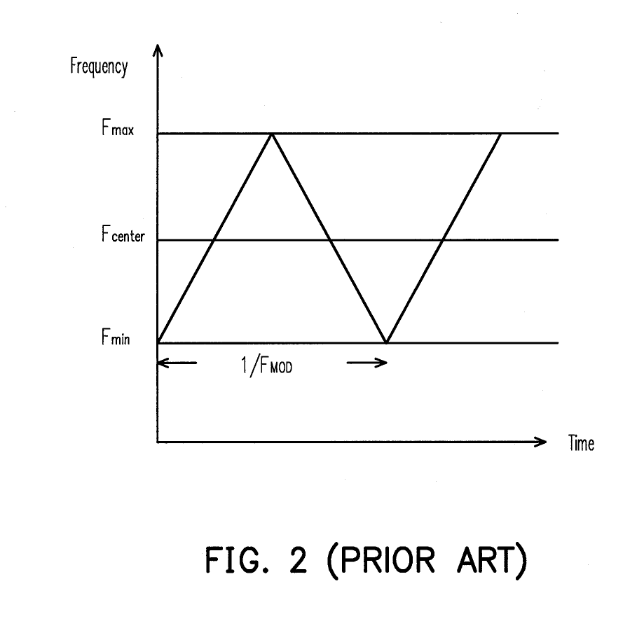

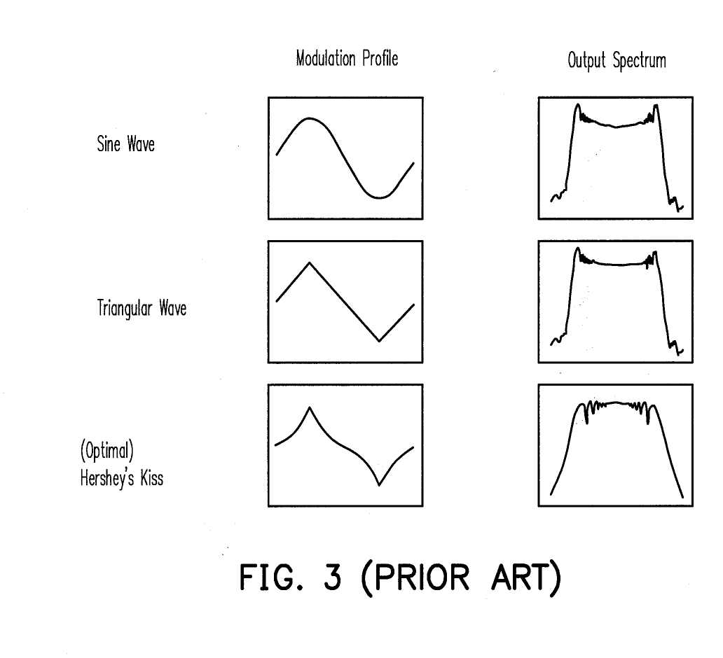

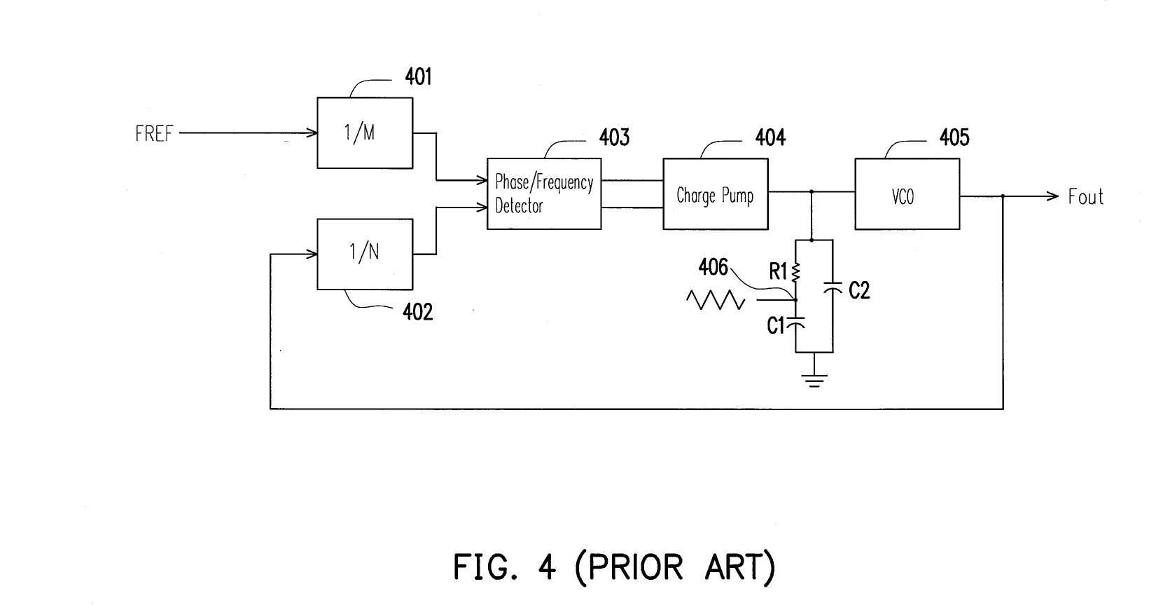

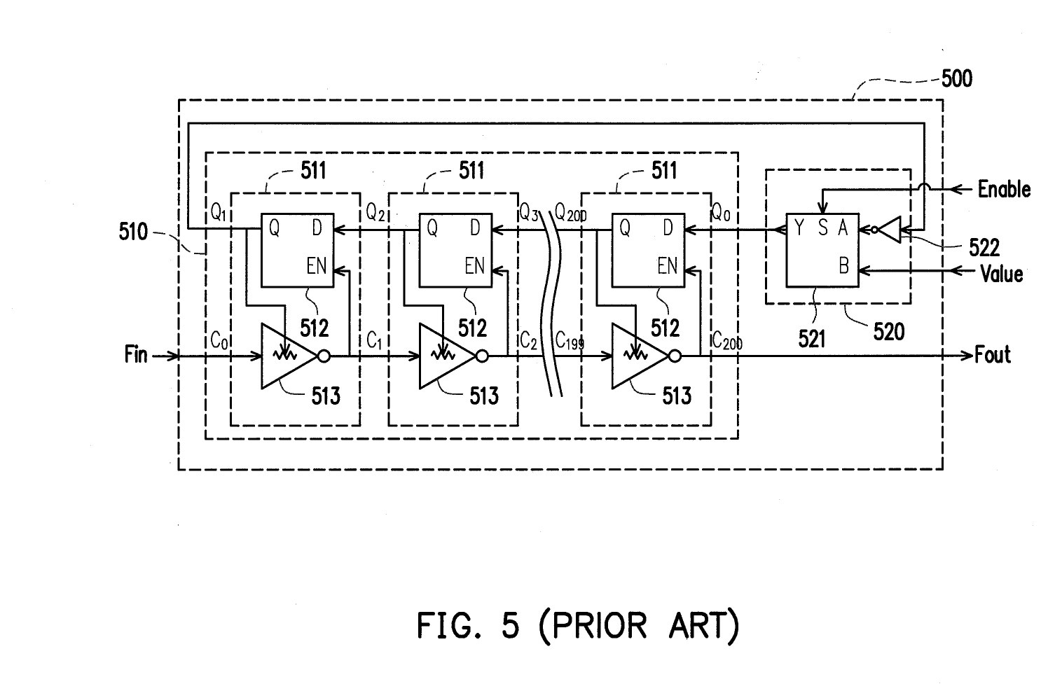

### DESCRIPTION OF THE EMBODIMENTS

Reference will now be made in detail to the present preferred embodiments of the invention, examples of which are illustrated in the accompanying drawings. Wherever possible, the same reference counting numbers are used in the drawings and the description to refer to the same or like parts.

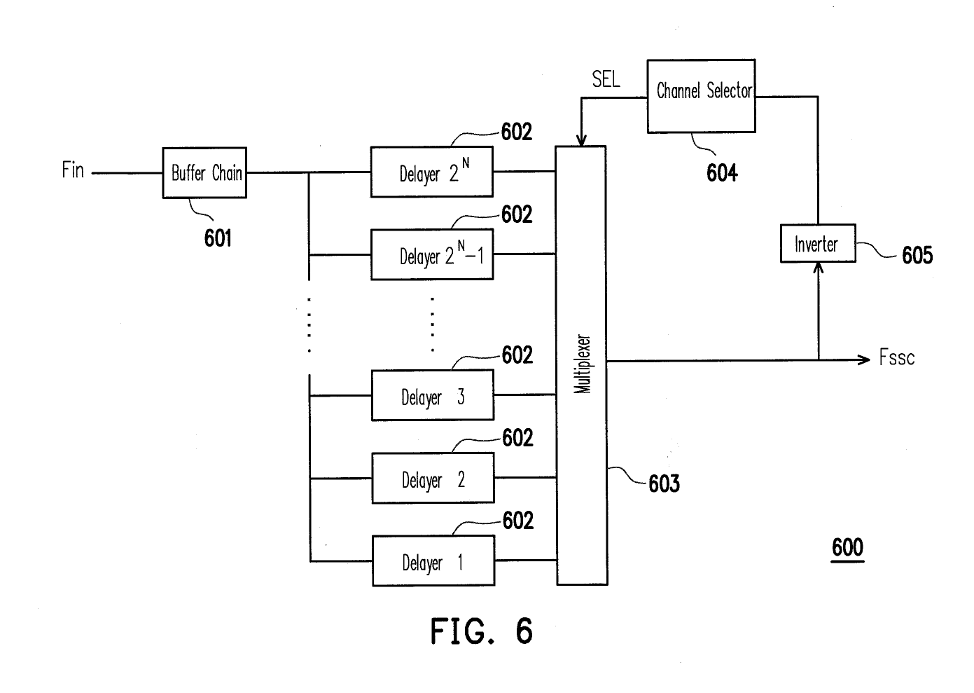

FIG. 6 is a schematic circuit diagram illustrating a spread-spectrum clock generator (SSCG) 600 according to an embodiment of the present invention. Referring to FIG. 6, the SSCG 600 adopts an all digital configuration, does not include a capacitor for reducing circuit area, and varies the conventional multistage serially connecting type delay to a parallel connecting type delay, for reducing the delay stages, and avoiding a variation of the duty cycle.

The SSCG 600 includes a buffer chain 601, 2^{N} delayers 602 (N is a predetermined positive integer), a multiplexer 603, a channel selector 604, and an inverter 605. The buffer chain 601 is coupled to all of the delayers 602, for transmitting an input clock signal Fin to each of the delayers 602, and driving every delayer 602. In order to drive multiple delayers 602, the buffer chain 601 is configured by a tree shape design, which is constituted of a plurality of buffers. Each of the delayers 602 delays the input clock signal Fin, respectively, for generating a delay clock signal. Each delayer 602 has a specific delay time. The multiplexer 603 is also coupled to all of the delayers 602, for selecting one of the delay clock signals outputted from the delayers 602 to serve as a spread-spectrum clock signal F_{SSC}. The inverter 605 is coupled to the multiplexer 603, for receiving the spread-spectrum clock signal F_{SSC}. The channel selector 604 is coupled between the multiplexer 603 and the inverter 605. The multiplexer 603 includes a plurality of input channels. Each input channel receives one delay clock signal. The channel selector 604 is provided for varying a selection signal SEL during each period of the spread-spectrum clock signal F_{SSC}, so as to allow the multiplexer 603 to select a different input channel during each period of the spread-spectrum clock signal F_{SSC}, serving as an output of the multiplexer 603, by which the spread-spectrum clock signal F_{SSC} achieves a spread-spectrum feature of frequency modulation. For example, the channel selector 604 includes an up-down counter, adapted for up-down counting a value according to an output of the inverter 605. The channel selector 604 can provide a counting value outputted from the up-down counter to the multiplexer 603 serving as the selection signal SEL.

The inverter 605 is provided for allowing the multiplexer 603 to use the falling edge of the spread-spectrum clock signal F_{SSC} to sample the rising edge thereof, for avoiding prospective problem of clock sequence. However, if such a problem is not concerned, the inverter 605 can thus be omitted.

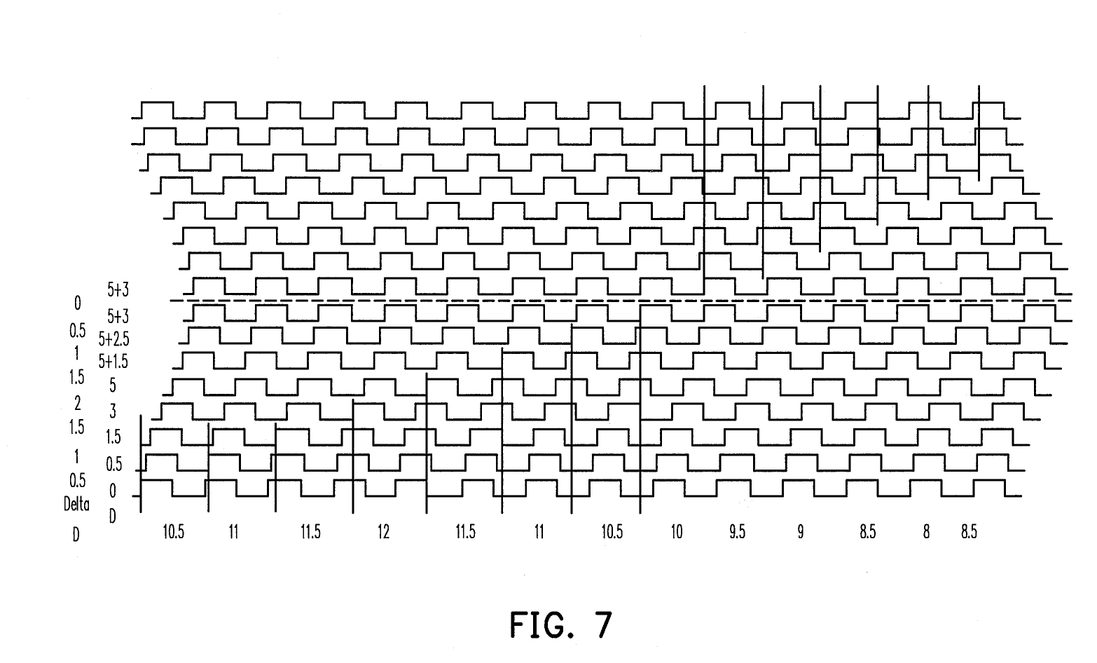

The operation principle of the SSCG 600 is to be discussed below. FIG. 6 is a schematic circuit diagram illustrating an SSCG according to an embodiment of the present invention. FIG. 7 is a clock sequence diagram of the delay clock signals of the SSCG of FIG. 6. Referring to FIGS. 6 and 7, FIG. 7 illustrates a clock sequence diagram of the delay clock signals outputted by the delayers 602 according to the embodiment of the present invention. There are two columns of numerals listed at the left side of FIG. 7. The right column (D) lists delay times of every delayer 602, while the lowest numeral is the delay time of the first delayer 602, the second lowest numeral is the delay time of the second delayer 602, and the rest may be deduced by analogy. The left column (Delta D) lists differences between each two of the delay times of the delayers 602. The lowest numeral is the difference between the delay times of the first and the second delayers 602, the second lowest numeral is the difference between the delay times of the second and the third delayers 602, and the rest may be deduced by analogy.

During each period of the spread-spectrum clock signal F_{SSC}, the selection signal SEL outputted from the channel selector 604 varies, so that the multiplexer 603 selects a different delay clock signal to serve as the spread-spectrum clock signal F_{SSC}. For example, during the first period of the spread-spectrum clock signal F_{SSC}, the rising edge of the spread-spectrum clock signal F_{SSC} is derived from the delay clock signal outputted from the first delayer 602, and the rising edge of the spread-spectrum clock signal F_{SSC} of during the second period of the spread-spectrum clock signal F_{SSC} is derived from the delay clock signal outputted from the second delayer 602, and the rest may be deduced by analogy. According to such a rule, it can be learnt that if the input clock signal Fin has a period T, the spread-spectrum clock signal F_{SSC} has a period of T+(Delta D). As shown in FIG. 7, Delta D periodically varies between two predetermined values 0 and 2. Supposing that the period of the input clock signal Fin is 10 units, the period of the spread-spectrum clock signal F_{SSC} varies between 10 units and 12 units. A row of numerals listed at the bottom of FIG. 7 list lengths of the periods of the spread-spectrum clock signal F_{SSC}. In such a way, the SSCG 600 achieves the spread-spectrum modulating function.

In operation, the SSCG 600 still has some prospective difficulties. For example, the multiplexer 603 can be realized with a tree shape configuration constituted by two-to-one or multiple-to-one small multiplexers. However, the selection signal is a multi-byte signal, and when there are multiple bytes varying simultaneously, e.g., up counting from 01111 to become 10000, switching times of different multiplexer stages in the tree shape configuration may have slight differences. In other words, different multiplexer stages may be switched asynchronously. On the contrary, they may be switched in succession during a short transient time. Unfortunately, during such a transient time, the spread-spectrum clock signal F_{SSC} outputted from the multiplexer 603 may skip among several delay clock signals, thus generating a glitch.

Another prospective difficulty is that when the delayer 602 demands a relatively long delay time, a multiple serially connected delay configuration has to be adopted. Unfortunately, such a configuration still affects the duty cycle of the input clock signal Fin.

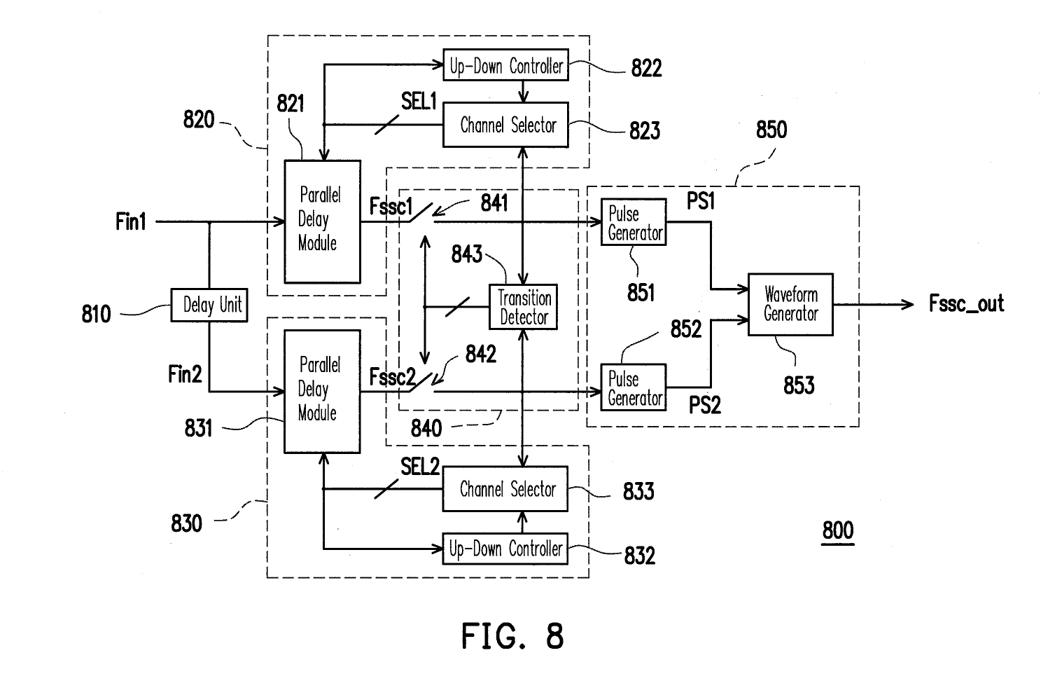

For providing a solution to the foregoing two prospective difficulties, the present invention further provides an SSCG, as shown in FIG. 8. FIG. 8 is a schematic circuit diagram illustrating an SSCG according to another embodiment of the present invention. Referring to FIG. 8, the SSCG 800 includes a delay unit 810, a first spread-spectrum modulator 820, a second spread-spectrum modulator 830, a switch module 840, and a waveform module 850. The delay unit 810 is coupled with the second spread-spectrum modulator 830. The switch module 840 is coupled with the first spread-spectrum modulator 820, and the second spread-spectrum modulator 830. The waveform module 850 is coupled to the switch module 840.

The delay unit 810 receives a first input clock signal Fin1, and delays the first input clock signal Fin1 for a predetermined delay time and outputs the delayed Fin1 as a second input clock signal Fin2. Preferably, the phase delay time of the first input clock signal Fin1 is about a half period thereof. For example, the delay unit 810 includes an inverter adapted for receiving Fin1 and outputting Fin2, for delaying the phase of Fin1 for a half period. However, the present invention prefers the delay unit 810 to be capable of delaying Fin 1 for about a half period but does not restrict the delay unit 810 as realized with an inverter.

The first spread-spectrum modulator 820 employs the parallel delaying configuration as same as the SSCG 600 of FIG. 6, in which the first input clock signal Fin1 is modulated to generate a first spread-spectrum clock signal F_{SSC1}. The second spread-spectrum modulator 830 also employs the parallel delaying configuration as same as the SSCG 600, in which the first input clock signal Fin2 is modulated to generate a first spread-spectrum clock signal F_{SSC2}. Circuits of the first spread-spectrum modulator 820 and the second spread-spectrum modulator 830 are exactly identical. As such only details of the first spread-spectrum modulator 820 is to be disclosed herebelow, while the second spread-spectrum modulator 830 is not to be iterated hereby.

The first spread-spectrum modulator 820 includes a parallel delay module 821, a channel selector 823, and an up-down controller 822. The parallel delay module 821 includes a plurality of delayers and a multiplexer, which are connected as same as the delayers 602 and the multiplexer 603 as shown in FIG. 6. Each delayer of the parallel delay module 821 delays the first input clock signal Fin1, respectively, and generates an individual delay clock signal. Delay times of the delayers, and differences between each two of the delay times of the delayers are the same as the numeral sequences shown in FIG. 7. As such, the parallel delay module 821 can achieve similar modulating function. The multiplexer of the parallel delay module 821 is coupled to the delayers, and is adapted for selecting one of the delay clock signals to serve as the first spread-spectrum clock signal F_{SSC1} according to a first selection signal SEL1. The channel selector 823 is coupled to the multiplexer of the parallel delay module 821, for varying the first selection signal SEL1 during each period of the first spread-spectrum clock signal F_{SSC1} so that the multiplexer of the parallel delay module 821 selects a different input channel during each period of the first spread-spectrum clock signal F_{SSC1} for outputting. In such a way, the first spread-spectrum clock signal F_{SSC1} achieves a modulating function of spread-spectrum. The channel selector 823 for example includes an up-down counter, adapted for up-down counting a value according to the first spread-spectrum clock signal F_{SSC1}. The channel selector 823 provides the counting value outputted from the up-down counter to the multiplexer for serving as the first selection signal SEL1.

The up-down controller 822 is coupled to the channel selector 823, for controlling an upper counting limit and a lower counting limit of the up-down counter of the channel selector 823 according to the first selection signal SEL1. The up-down controller is provided for restricting a counting range of the up-down counter, in which when the up-down counter counts to a predetermined upper limit or a predetermined lower limit, the up-down counter reversely counts. An N-byte up-down counter can generate 2^{N} different counting values. However, the parallel delay module 821 usually does not include delayers as much as the counting values. If the amount of the delayers is less than 2^{N}, the up-down controller 822 is necessary for restricting the counting range of the up-down counter, for preventing undesired first selection signal SEL1.

The switching module 840 includes a first switch 841, a second switch 842, and a transition detector 843. The first switch 841 is coupled between a parallel delay module 821 of the first spread-spectrum module 820 and a first pulse generator 851 of the waveform module 850. The second switch 842 is coupled between a parallel delay module 831 of the second spread-spectrum module 830 and a second pulse generator 852 of the waveform module 850. The transition detector 843 is coupled with the first switch 841 and the second switch 842. At a rising edge of the first spread-spectrum clock signal F_{SSC1}, the transition detector 843 turns off the first switch 841, and turns on the second switch 842. At a rising edge of the second spread-spectrum clock signal F_{SSC2}, the transition detector 843 turns on the first switch 841 and turns off the second switch 842.

The switch module 840 is adapted for avoiding the switching glitch. Because of the delay unit 810, rising edges of the first spread-spectrum clock signal F_{SSC1} and the second spread-spectrum clock signal F_{SSC2} appear alternately. At the beginning, the first switch 841 is turned on, and the second switch 842 is turned off. When the transition detector 843 detects the rising edge of the first spread-spectrum clock signal F_{SSC1}, the transition detector 843 turns off the first switch 841, and turns on the second switch 842. The rising edge of the first spread-spectrum clock signal F_{SSC1} goes further to the first pulse generator 851 and the channel selector 823. Therefore, the cutting off of the first switch 841 does not affect the operation of the SSCG 800. Later, the channel selector 823 is triggered by the rising edge of the first spread-spectrum clock signal F_{SSC1} to start counting, and vary the first selection signal SEL1 Meanwhile, the first switch 841 has been already cut off, and therefore even though there is a glitch generated when the multiplexer of the parallel delay module 821 is switching, the glitch will be stopped by the first switch 841 without causing any disadvantageous affection.

Likewise, when a rising edge of the second spread-spectrum clock signal F_{SSC2} passes the second switch 842 and is detected by the transition detector 843, the transition detector 843 turns on the first switch 841, and turns off the second switch 842. In such a way, when a second selection signal SEL2 varies, even though the multiplexer of the parallel delay module 831 may generate a glitch, the glitch will be stopped by the second switch without causing any disadvantageous affection.

The alternately switching between the first switch 841 and the second switch 842, is adapted for stopping glitches potentially generated by the multiplexers of the parallel delay module 821 and 831. In such a way, even when there is a glitch generated, the glitch won't affect the final output signal F_{SSC}_{_{—}}ₒᵤₜ. As such, the switch module 840 provides a solution to the foregoing switching glitch difficulty. However, it should be noted that when there is no question about the switching glitch, the switch module 840 can be omitted.

The waveform module 850 includes a first pulse generator 851, a second pulse generator 852, and a waveform generator 853. The first pulse generator 851 is coupled to the first switch 841. The second pulse generator 852 is coupled to the second switch 842. The waveform generator 853 is coupled to the first pulse generator 851 and the second pulse generator 852. When receiving the rising edge of the first spread-spectrum clock signal F_{SSC1}, the first pulse generator 851 generates a first pulse signal PS1, for indicating the rising edge position of the first spread-spectrum clock signal F_{SSC1}. When receiving the rising edge of the first spread-spectrum clock signal F_{SSC1}, the second pulse generator 852 generates a first pulse signal PS2, for indicating the rising edge position of the second spread-spectrum clock signal F_{SSC2}. When receiving the first pulse signal PS1, the waveform generator 853 generates a rising edge of the output spread-spectrum clock signal F_{SSC}_{_{—}}ₒᵤₜ, and when receiving the second pulse signal PS2, the waveform generator 853 generates a falling edge of the output spread-spectrum clock signal F_{SSC}_{_{—}}ₒᵤₜ.

As shown in FIG. 8, the circuit of the SSCG 800 is up down symmetrical. The upper half portion is responsible for generating the rising edge of the spread-spectrum clock signal F_{SSC}_{_{—}}ₒᵤₜ, and the lower half portion is responsible for generating the falling edge of the spread-spectrum clock signal F_{SSC}_{_{—}}ₒᵤₜ. After processed by the inverter of the delay unit 810, the first input clock signal Fin1 becomes the second input clock signal Fin2. A single stage of inverter usually produces neglectable affection to the duty cycle. As such, because of the symmetry of the SSCG 800, after passing through the delay unit 810, the first input clock signal Fin1 and the second input clock signal Fin2 pass exactly symmetrical paths, and are equivalently delayed. As such, a time difference between the rising edge and the falling edge of the output spread-spectrum clock signal F_{SSC}_{_{—}}ₒᵤₜ is very much close to a time difference between the rising edge of the first input clock signal Fin1 and the rising edge of the second input clock signal Fin2. In other words, the duty cycle of the output spread-spectrum clock signal F_{SSC}_{_{—}}ₒᵤₜ is not greatly varied. In summary, by employing the symmetrical circuit and the waveform module 850, the SSCG 800 is adapted for providing a solution for the duty cycle difficulty of the conventional technology.

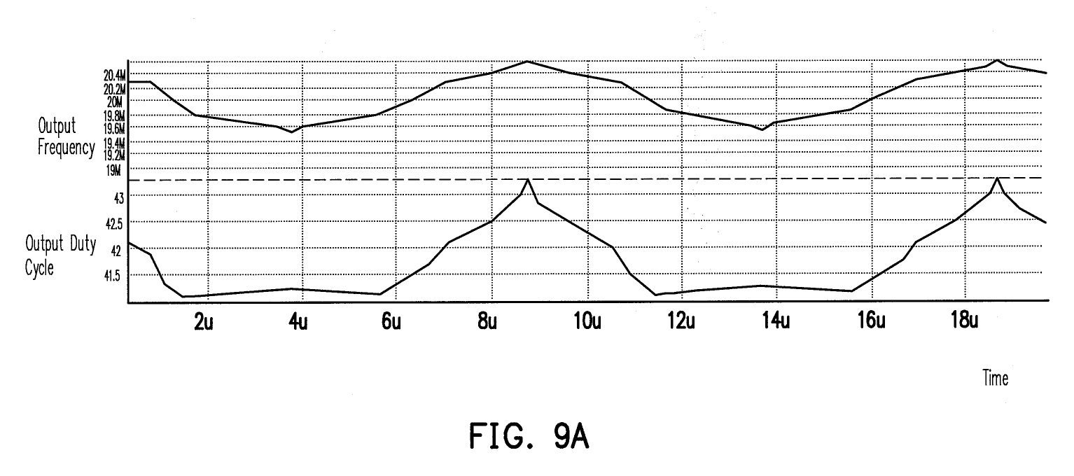

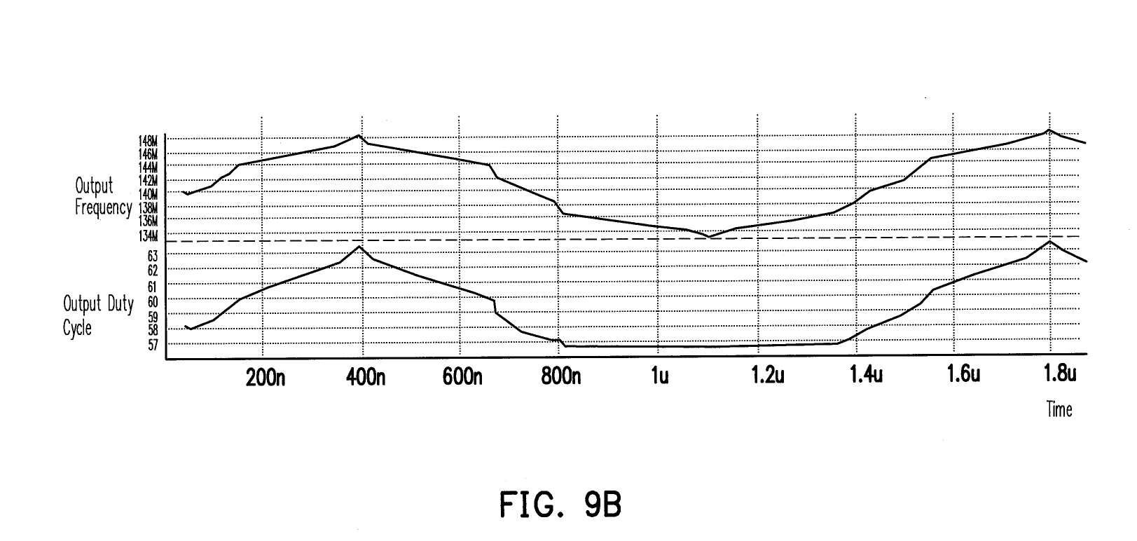

FIGS. 9A and 9B are simulations of the SSCG of FIG. 8. As shown in FIG. 9A, it illustrates a simulation result of the frequency and duty cycle of the output signal F_{SSC}_{_{—}}ₒᵤₜ, in conditions of the input signal Fin1 having a frequency of 20 MHz, the modulation percentage (MP) being ±2.5%, and the modulation frequency (MF) being 100 KHz. It can be learnt from FIG. 9A, the modulation profile of the output signal F_{SSC}_{_{—}}ₒᵤₜ is approximate to a triangle wave when approaching to the center frequency 20 MHz, and is approximate to a Hershey's Kiss when approaching to the upper and lower frequency limits. The duty cycle of the output signal F_{SSC}_{_{—}}ₒᵤₜ varies within a range of 41% to 43.5%, which is not very much different from the input signal Fin1. FIG. 9B illustrates a simulation result of the frequency and duty cycle of the output signal F_{SSC}_{_{—}}ₒᵤₜ, in conditions of the input signal Fin1 having a frequency of 140 MHz, the MP being ±6.4%, and the MF being 700 KHz. It can be learnt from FIG. 9B, the duty cycle of the output signal F_{SSC}_{_{—}}ₒᵤₜ is still approximate to the duty cycle of the input signal Fin1 without much variation.

Beside the SSCG, the present invention further provides a corresponding spread-spectrum clock generating method. As discussed in the foregoing embodiments, the SSCG 600 applies with an embodiment of the spread-spectrum clock generating method of the present invention. Details of the spread-spectrum clock generating method have been discussed above, and are not to be iterated hereby.

In summary, the present invention provides an optimal solution for the difficulties about the capacitor areas, and the duty cycle of the conventional technologies, and is adapted for providing a practically usable SSCG and a practically usable spread-spectrum clock generating method. The present invention does not require a large area capacitor, and therefore the area of the SSCG of the present invention is only about a half of that of a conventional SSCG adopting a PLL configuration. The present invention is further adapted for greatly shortening the latch time. Comparing with the conventional SSCG employing a serially connecting delay configuration, despite the processing variation, the operation voltage variation, and the temperature variation, the symmetrical parallel delay configuration employed by the present invention can maintain the duty cycle of the output signal within an acceptable range, and the output signal will not seriously deform.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A spread-spectrum clock generator (SSCG), comprising:
a plurality of delayers, each of the delayers delaying an input clock signal, and generating a delay clock signal;
a multiplexer, coupled to the delayers, for selecting one of the delay clock signals according to a selection signal to serve as a spread-spectrum clock signal; and
a channel selector, coupled to the multiplexer, for providing the selection signal, and varying the selection signal during each period of the spread-spectrum clock signal.

2. The SSCG according to claim 1, wherein differences between each two of the delay times of the delayers constitute a numeral sequence and the numerical sequence periodically varies between two predetermined values.

3. The SSCG according to claim 1, wherein the channel selector comprises:
an up-down counter, for counting a value according to the spread-spectrum clock signal, and providing the counting value serving as the selection signal.

4. The SSCG according to claim 1, further comprising:
a buffer chain, coupled to the delayers, for transmitting the input clock signal to the delayers, and driving the delayers.

5. The SSCG according to claim 1, further comprising:
an inverter, coupled between the multiplexer and the channel selector, for receiving the spread-spectrum clock signal, wherein the channel selector varies the selection signal during each period of an output signal of the inverter.

6. A spread-spectrum clock generating method, comprising:
delaying an input clock signal according to a plurality of delay times respectively, and generating a plurality of delay clock signals;
selecting one of the delay clock signals according to a selection signal to serve as a spread-spectrum clock signal; and
up-down counting a value according to the spread-spectrum clock signal, and providing the counting value serving as the selection signal.

7. The spread-spectrum clock generating method according to claim 6, wherein differences between each two of the delay times constitute a numeral sequence and the numerical sequence periodically varies between two predetermined values.

8. A spread-spectrum clock generator (SSCG), comprising:
a first spread-spectrum module, adapted for modulating a first input clock signal, and generating a first spread-spectrum clock signal;
a second spread-spectrum module, adapted for modulating a second input clock signal and generating a second spread-spectrum clock signal; and
a waveform module, coupled to the first spread-spectrum module and the second spread-spectrum module, for generating an output spread-spectrum clock signal according to the first spread-spectrum clock signal and the second spread-spectrum clock signal.

9. The SSCG according to claim 8, wherein the first spread-spectrum module and the second spread-spectrum module have a same circuit configuration, and the second input clock signal is generated according to the first input clock signal.

10. The SSCG according to claim 9, further comprising:
a delay unit, coupled to the second spread-spectrum module, for receiving the first input clock signal, and delaying the first input clock signal for a predetermined time and then outputting the delayed first input clock signal to the second spread-spectrum module as the second input clock signal.

11. The SSCG according to claim 10, wherein the delay unit comprises:
an inverter, for receiving the first input clock signal and outputting the second input clock signal.

12. The SSCG according to claim 9, wherein the first spread-spectrum module comprises:
a plurality of delayers, each of the delayers delaying the first input clock signal and generating a delay clock signal;
a multiplexer, coupled to the delayers, for selecting one of the delay clock signals according to a selection signal to serve as a first spread-spectrum clock signal; and
a channel selector, coupled to the multiplexer, for providing the selection signal, and adapted for varying the selection signal during each period of the first spread-spectrum clock signal.

13. The SSCG according to claim 12, wherein differences between each two of the delay times of the delayers constitute a numeral sequence and the numerical sequence periodically varies between two predetermined values.

14. The SSCG according to claim 12, wherein the channel selector comprises:
an up-down counter, for counting a value according to the first spread-spectrum clock signal, and providing the counting value serving as the selection signal.

15. The SSCG according to claim 12, wherein the first spread-spectrum module further comprises:
an up-down controller, coupled to the channel selector, for controlling the channel selector according to the selection signal, so as to control an upper limit and a lower limit of the selection signal.

16. The SSCG according to claim 8, further comprising:
a switch module, coupled between the first spread-spectrum module, the second spread-spectrum module, and the waveform module, for disconnecting the first spread-spectrum clock signal from the waveform module and connecting the second spread-spectrum clock signal with the waveform module at a rising edge of the first spread-spectrum clock signal, and connecting the first spread-spectrum clock signal with the waveform module and disconnecting the second spread-spectrum clock signal from the waveform module at a rising edge of the second spread-spectrum clock signal.

17. The SSCG according to claim 16, wherein the switch module comprises:
a first switch, coupled between the first spread-spectrum module and the waveform module;
a second switch, coupled between the second spread-spectrum module and the waveform module; and
a transition detector, coupled with the first switch and the second switch, and adapted for turning off the first switch and turning on the second switch at the rising edge of the first spread-spectrum clock signal, and turning on the first switch and turning off the second switch at the rising edge of the second spread-spectrum clock signal.

18. The SSCG according to claim 8, wherein the waveform module comprises:
a first pulse generator, coupled with the first spread-spectrum module, for generating a first pulse signal at the rising edge of the first spread-spectrum clock signal;
a second pulse generator, coupled with the second spread-spectrum module, for generating a second pulse signal at the rising edge of the second spread-spectrum clock signal; and
a waveform generator, coupled with the first pulse generator and the second pulse generator, for generating the output spread-spectrum clock signal, wherein a rising edge of the output spread-spectrum clock signal is generated according to the first pulse signal, and a falling edge of the output spread-spectrum clock signal is generated according to the second pulse signal.

19. A spread-spectrum clock generating method, comprising:
using a predetermined spread-spectrum method for modulating a first input clock signal to obtain a first spread-spectrum clock signal;
using the predetermined spread-spectrum method for modulating a second input clock signal to obtain a second spread-spectrum clock signal; and
generating an output spread-spectrum clock signal according to the first spread-spectrum clock signal and the second spread-spectrum clock signal.

20. The spread-spectrum clock generating method according claim 19, wherein the second input clock signal is an inverted signal of the first input clock signal.

21. The spread-spectrum clock generating method according claim 19, wherein the predetermined spread-spectrum method with respect to the first input clock signal comprises:
delaying the first input clock signal according to a plurality of delay times respectively and generating a plurality of delay clock signals;
selecting one of the delay clock signals according to a selection signal to serve as the first spread-spectrum clock signal; and
up-down counting a value according to the first spread-spectrum clock signal, and providing the counting value serving as the selection signal.

22. The spread-spectrum clock generating method according claim 21, wherein differences between each two of the delay times constitute a numeral sequence and the numerical sequence periodically varies between two predetermined values.

23. The spread-spectrum clock generating method according claim 19, wherein a rising edge of the output spread-spectrum clock signal is generated according to a rising edge of the first spread-spectrum clock signal, and a falling edge of the output spread-spectrum clock signal is generated according to a rising edge of the second spread-spectrum clock signal.
